(19) United States
(12) Patent Application Publication
(10) Pub. No.: US 2015/0334138 A1
(43) Pub. Date: Nov. 19, 2015

(54) TRANSFERRING CONTENT BETWEEN GRAPHICAL USER INTERFACES

(71) Applicant: Microsoft Corporation, Redmond, WA (US)

(72) Inventors: Skji Martens Conklin, Seattle, WA (US); Nathan James Fish, Seattle, WA (US); Philip Lindsley Davidson, Seattle, WA (US)

(21) Appl. No.: 14/522,525

(22) Filed: Oct. 23, 2014

Related U.S. Application Data
(60) Provisional application No. 61/996,781, filed on May 14, 2014.

(51) Int. Cl. H04L 29/06; G06F 3/0481

(52) U.S. Cl. CPC H04L 65/403; G06F 3/0481

(57) ABSTRACT

A method for providing collaborative communication between computing devices is provided. The method includes at a receiver computing device, displaying a first graphical user interface (GUI) and a second GUI on an interactive display, the first GUI associated with a remotely executed sender application program executed on a sender computing device having a local peer-to-peer wireless connection with the receiver sender computing device and the second GUI associated with a locally executed receiver application program executed on the receiver computing device, receiving a user input from the interactive display indicating user interaction with the first GUI and the second GUI, sending a content request to the sender application program from the receiver application program based on the user input, receiving the content requested from the sender application program, and updating the second GUI based on the content transferred from the sender application program to the receiver application program.

### CROSS REFERENCE TO RELATED APPLICATION

This application claims priority to U.S. provisional patent application, Ser. No. 61/996,781, entitled “CLAIMING DATA FROM A VIRTUAL WHITEBOARD” filed on May 14, 2014, the entire disclosure of which is herein incorporated by reference.

### BACKGROUND

Computing devices such as laptops, desktops, etc., may be locally projected to larger displays such as projectors, liquid crystal displays (LCDs), etc., to enable viewing of the content generated on the source computing device by a greater number of people during, for example, a presentation, meeting, etc. This type of projected viewing is useful in a larger number of fields such as engineering, marketing, business, education, etc. Cords, such as video graphics array (VGA) cords, may be used to provide a wired connection between the source computing device and the projection device. However, it may be inefficient and time consuming to connect the computing device to the projection device in this way. More recently, wireless connectivity has been used to link source computing devices to projection devices, to simplify the connection process. While this type of connection may be established in less time than a wired connection, wirelessly connecting the devices in this way to enable projection still has a number of drawbacks. For instance, interaction with the content sent to the projection device from the source computing device and displayed on the projection device can only be manipulated via the source computing device. This type of interaction with the source device to manipulate content can be time consuming and subject to frequent interruption. For instance, a user may have to travel between the devices during the presentation to change a slide, highlight a field, etc., which may interfere with the presentation.

### SUMMARY

A method for providing collaborative communication between computing devices is described herein. The method includes, at a receiver computing device, displaying a first graphical user interface (GUI) and a second GUI on an interactive display, the first GUI associated with a remotely executed sender application program executed on a sender computing device having a local peer-to-peer wireless connection with the receiver sender computing device and the second GUI associated with a locally executed receiver application program executed on the receiver computing device, receiving a user input from the interactive display indicating user interaction with the first GUI and the second GUI, sending a content request to the sender application program from the receiver application program based on the user input, receiving the content requested from the sender application program, and updating the second GUI based on the content transferred from the sender application program to the receiver application program.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. Furthermore, the claimed subject matter is not limited to implementations that solve any or all disadvantages noted in any part of this disclosure.

### BRIEF DESCRIPTION OF THE DRAWINGS

FIG. 1 is a schematic depiction of an example computing system;

FIG. 2 is an illustration of an example receiver device;

FIGS. 3-5 illustrate a flowchart of one example of a method for providing collaborative interaction between a sender computing device and a receiver computing device; and

FIGS. 6-10 are illustrations of graphical user interfaces (GUIs) displayed on the receiver computing device.

### DETAILED DESCRIPTION

A system and method that enables interaction between two computing devices linked via a local peer-to-peer wireless connection to provide graphical projection capabilities between the devices as well as graphical content manipulation and management on the device receiving remotely executed graphical data are described herein. The computing devices are referred to as a sender computing device and a receiver computing device. The receiver computing device is configured to display both a locally executed graphical user interface (GUI) and a remotely executed GUI executed by the sender computing device and wirelessly transmitted to the receiver computing device. The receiver computing device may further be configured to transfer content between the remotely executed GUI and the locally executed GUI displayed by the receiver computing device over the local peer-to-peer wireless connection. For instance, content may be cut and copied or cut and pasted between the locally and remotely executed GUIs, in one example. In this way, the receiver computing device can act not only as a projection device but also provide interactive input corresponding to graphics displayed on the receiver computing device that are executed both remotely and locally. As a result, the functionality of the receiver computing device is expanded to provide a greater number of programmatic tools that enable users to quickly and intuitively move content between two discretely executed GUIs displayed by the receiver computing device. It will be appreciated that the computing devices with the aforementioned functionality may be used in meetings or other collaborative settings to enable intuitive and seamless flow of content between multiple sources without undue user input, wired connections, etc. Consequently, the user experience for content management in the computing devices can be improved.

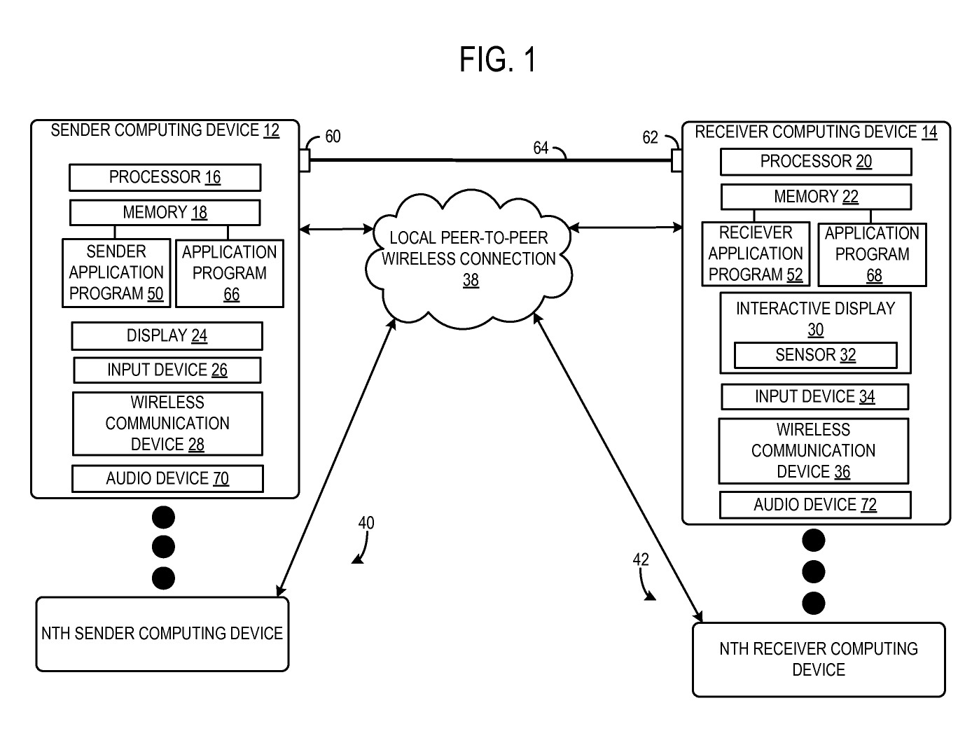

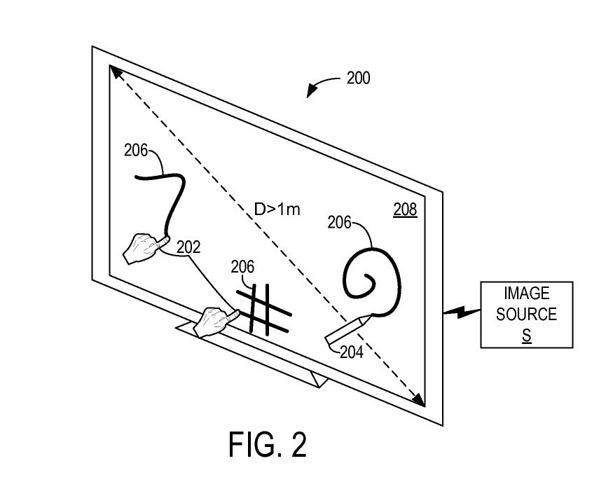

FIG. 1 illustrates a computing system 10 including a sender computing device 12 and a receiver computing device 14. It will be appreciated that the sender computing device may a suitable computing device including, but not limited to, desktop computing device, a laptop computer, a portable electronic device, a tablet computing device, media player, mobile telephone, etc. The receiver computing device may be a computing device with a larger display, for example. Specifically in one example, the receiver computing device may be a large format (e.g., greater than 40 inches) screen display with application program processing capabilities, which for example, may be mounted on a wall in a classroom, conference room, or office for use in group interactions. However, a multitude of different types of computing devices have been contemplated. An exemplary embodiment of the receiver computing device is described in greater detail herein with regard to FIG. 2.

As illustrated the sender computing device 12 includes a processor 16 and memory 18. Likewise, the receiver computing device 14 includes a processor 20 and a memory 22. The memory 18 and memory 22 includes code stored therein executable by the associated processor to implement the methods, techniques, routines, and other functions described herein.

The sender computing device 12 further includes a display 24 (e.g., liquid crystal display (LCD), active-matrix organic light emitting (AMOLED), cathode ray tube (CRT), etc.), an input device 26 (e.g., mouse, keyboard, touch-pad, track-pad, touch sensitive display, combinations thereof etc.), and a wireless communication device 28 (e.g., Bluetooth device, WI-FI device, near field communication device, infrared communication, wireless modem, combinations thereof, etc.). It will be appreciated that a WI-FI device may be configured to support a WI-FI direct connection which enables the computing devices to communicate without a wireless access point, if desired. Therefore, in some examples the WI-FI device may be referred to as a WI-FI direct device.

The sender computing device 12 may further include a connection port 60 supporting a wired connection with the sender computing device. In this way, the sender computing device 12 can send/receive electronic data via a wired connection, if desired. A multitude of suitable connection ports or combinations of connection ports have been contemplated. For instance, the connection port 60 may be a Universal Serial Bus (USB) port, an Ethernet port, Fire-Wire, video graphics array (VGA), a combination thereof, etc. The sender computing device 12 may also include an audio device 70 configured to project and/or receive audio signals. Thus, the audio device 70 may include one or more of a speaker, microphone, etc. It will be appreciated that the display 24, input device 26, wireless communication device 28, connection port 60, and/or audio device 70 are in electronic communication with the processor 16 and memory 18 as well as one another, in some examples.

Additionally, the sender computing device 12 and the receiver computing device 14 may be co-located, in one example. For instance, the computing devices (12 and 14) may be located in the same room, building, structure, etc. The distance between the sender computing device and receiver computing device may be determined via the characteristics of the wireless communication devices used to provide wireless connectivity. It will be appreciated that it may be desirable for the computing devices to be positioned nearby to one another to enable user(s) to interact with both of the computing devices over a wireless local area network (WLAN), if desired. However in other examples the sender and receiver computing devices may be positioned at remote locations and connected via a wider network, such as a wide area network (WAN).

The receiver computing device 14 includes an interactive display 30 (e.g., interactive touch sensitive display) including a sensor 32 (e.g., touch sensor), an input device 34 (e.g., mouse, keyboard, track-pad, touch-pad, combinations thereof, etc.), and a wireless communication device 36 (e.g., Bluetooth device, WI-FI device, near field communication device, wireless modem, combinations thereof, etc.). In one example, the interactive display 30 may have a larger viewing area than the display 24. In this way, the interactive display 30 may be easily viewed by a number of people, if desired. Consequently, receiver computing device 14 may be utilized in meetings, presentations, lectures, etc., if desired. Further in some examples, the sensor 32 may be a capacitive sensor (e.g., capacitive touch sensor) configured to detect an electrical change from a touch or stylus input implemented by a user. Other touch sensing technologies may alternatively be adopted, such as optical touch sensing using frustrated total internal reflection, or camera-in-pixel technologies.

A stylus input may be an in input, in one example. However, other types of touch sensors have been contemplated such as an optical touch sensor, a resistive touch sensor, etc. The receiver computing device 14 may also include a connection port 62 supporting a wired connection. In this way, the receiver computing device 14 can send/receive electronic data via a wired connection, if desired. A multitude of suitable connection ports or combinations of connection ports have been contemplated. For instance, the connection port 62 may be a Universal Serial Bus (USB) port, an Ethernet port, Fire-Wire, video graphics array (VGA), or a combination thereof. The receiver computing device 14 may also include an audio device 72 configured to project and/or receive audio signals. Thus, the audio device 72 may include one or more of a speaker, microphone, etc. It will be appreciated that the interactive display 30, input device 34, wireless communication device 36, and/or audio device 72 are in electronic communication with the processor 20 and memory 22 as well as one another, in some examples.

The wireless communication devices (28 and 36) are configured to enable the computing devices (12 and 14) to wirelessly connect via a local peer-to-peer connection (e.g., local bi-directional peer-to-peer wireless connection). Thus, the sender computing device 12 and the receiver computing device 14 may be in wireless communication via a local peer-to-peer wireless connection 38. The local peer-to-peer wireless connection 38 may include a Bluetooth connection, a WI-FI connection (e.g., WI-FI direct connection), etc. The Bluetooth connection may be used to broadcast, discover, and establish connections between devices, which requires a relatively small amount of data transfer, and the WI-FI connection may be used to transfer large files between the devices. In one example, the computing devices may only be electronically connected via the local peer-to-peer wireless connection, and may not share any other network connection over which data may be transferred between the devices. Further in one example, the computing devices may be electronically connected via the wireless connection (i.e., local peer-to-peer wireless) over a local network (e.g., local area network (LAN)), and they may both be connected to the same wireless access point. Still further in other examples, the computing devices may be connected by both a wired and wireless connection. Therefore, it will be appreciated that the sender computing device 12 and receiver computing device 14 can be linked via a wired connection 64, if desired. The wired connection 64 may include one or more cables, cords, etc., configured to connect to the connection port 60 of the sender computing device 12 and the connection port 62 of the receiver computing device 14. Still further in one example, a local area network may not be used to connect the computing devices and there may be no intermediary devices (e.g., computing devices, servers, etc.,) in the communication path between the sender computing device 12 and the receiver computing device 14. Therefore, the sender computing device 12 may be in direct wireless communication with the receiver computing device 14 via the local peer-to-peer wireless connection, using an ad-hoc point to point connection.

It will be appreciated that the computing system 10 may further include a plurality of sender computing devices 40 and a plurality of receiver computing devices 42. The plurality of sender computing devices 40 and receiver computing devices 42 may include similar components to the sender computing device 12 and receiver computing device 14, respectively. However it will be appreciated that the type, size, etc., of the specific components in the devices may vary from device to device. Additionally, the plurality of sender computing devices 40 may be in wireless communication via the plurality of receiver computing devices 42 via the local peer-to-peer wireless connection 38.

A sender application program 50 may be stored in the memory of the 18 of the sender computing device 12. The sender application program 50 may be configured to provide the interactive wireless connectivity with the receiver computing device 14, described in greater detail herein. Likewise, a receiver application program 52 may be stored in the memory of the 22 of the receiver computing device 14. The receiver application program 52 may be configured to provide the interactive wireless connectivity with the sender computing device 14, described in greater detail herein. Thus, the sender application program 50 and the receiver application program 52 may work together to provide the peer-to-peer wireless connectivity (e.g., local bi-directional peer-to-peer wireless connectivity) between the computing devices. However in other examples alternate programmatic elements may be used to carry out this functionality. The sender computing device 12 may also be configured to locally execute another application program 66. It will be appreciated that the application program 66 may be referred to as a second application program. The application program 66 may be a spreadsheet application program, a word processing application program, a drawing application program, a web browser application program, an email application program, etc. It will be appreciated that in one example, graphics corresponding to the application program 66 may be presented within a GUI corresponding to the sender application program 50. However, other graphical configurations have been contemplated. Likewise, the receiver computing device 12 may also be configured to locally execute an application program 68. The application program 68 may be a graphics editing application program, a whiteboard application program, a spreadsheet application program, a word processing application program, a video editing application program, a drawing application program, etc. In one example, the application program 66 may be different than the application program 68. Additionally, it will be appreciated that in one example, graphics corresponding to the application program 68 may be presented within a GUI corresponding to the receiver application program 52.

The aforementioned application-programs may be stored in nonvolatile memory and executed via a corresponding processor and volatile memory in the each computing device. Furthermore, the application programs may be executed in the context of a desktop environment provided by an operating system stored in memory. However, the application programs may be provided in another programmatic framework, in other examples.

FIG. 2 shows an example receiver computing device 200. The receiver computing device 200 may be similar to the receiver computing device 14 shown in FIG. 1. Therefore, the receiver computing device 200 may include memory and a processor as well as the other components in the receiver computing device 14 shown in FIG. 1. Specifically, the receiver computing device may be a large format multi-touch computing device 200 in accordance with an example in the present disclosure. Receiver computing device 200 may have a diagonal dimension greater than 1 meter, for instance. In other, particularly large-format examples, the diagonal dimension may be 55 inches or greater. In another example, the receiver computing device may have a larger display than the sender computing devices to which it is wirelessly connected. Receiver computing device 200 may be configured to sense multiple sources of touch input, such as touch input applied by a digit 202 of a user or a stylus 204 manipulated by the user. It will be appreciated that a plurality inputs (e.g., touch and/or ink inputs) implemented at of simultaneous or overlapping time intervals can be sensed via the receiver computing device 200. Thus, the receiver computing device 200 may include a touch sensor, such as a capacitive touch sensor, as previously discussed. Additionally, it will be appreciated that ink input indicates stylus interaction with the touch screen. Likewise, a touch input indicates touch interaction with the touch screen, via one or more digits of a user, for instance.

Receiver computing device 200 may be connected to an image source S, such as an external computer or onboard processor. Image source S may receive multi-touch input from receiver computing device 200, process the multi-touch input, and produce appropriate graphical output 206 in response. Receiver computing device 200 may include a touch-sensitive display 208 (e.g., capacitive touch-sensitive display) to enable multi-touch sensing functionality of both touch input and ink input.

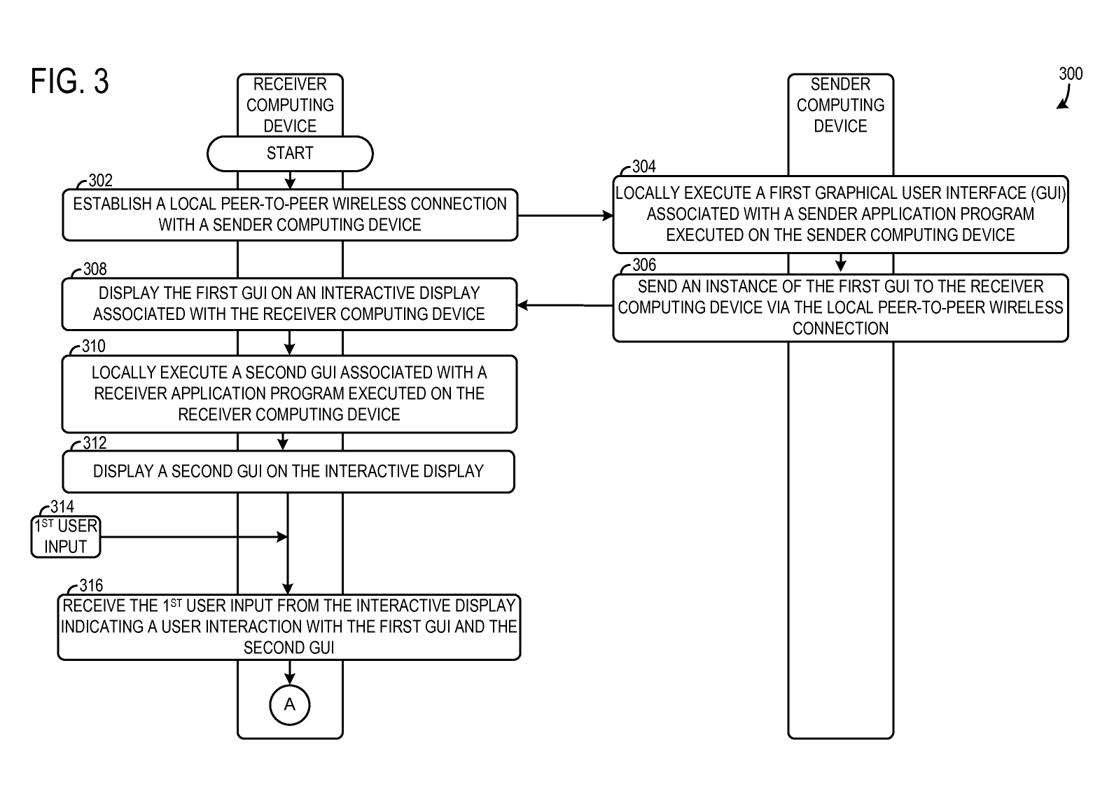

Turning now to FIG. 3, a method 300 for providing collaborative interaction between a receiver computing device and a sender computing device is illustrated. Method 300 may be implemented using the hardware and software components of the systems and devices described above. In particular, the method may be implemented via the receiver computing device 14. However, in alternate embodiments the method 300 may be implemented using other suitable hardware and software components.

At 302 the method includes establishing a local peer-to-peer wireless connection with a sender computing device. In one example, the sender computing device may initiate establishing the local peer-to-peer connection. In yet another example, the local peer-to-peer wireless connection includes at least one of a WI-FI connection (e.g., WI-FI direct connection) and a Bluetooth connection, and may include both such connections as described above.

Next, at 304 the method includes locally executing a first GUI associated with a sender application program executed on the sender computing device. At 306 the method includes sending an instance of the first GUI to the receiver computing device via the local peer-to-peer wireless connection.

Next, at 308 the method includes displaying the first GUI on an interactive display associated with the receiver computing device and at 310 the method includes locally executing a second GUI associated with a receiver application program executed on the receiver computing device.

At 312 the method includes displaying a second GUI on the interactive display (e.g., interactive touch screen). In one example, the first GUI and the second GUI are simultaneously displayed on the interactive display. Further in another example, the first GUI is presented within a window of the second GUI.

At 314 the method includes transferring a first user input to the receiver computing device from the interactive display. In one example, the first user input may include one or more of a touch input (e.g., multi-touch) and an ink input. The touch input may indicate one or more touch interactions with the interactive display and the ink input may indicate stylus interaction with the interactive touch screen. Still further in another example, the first user input may be one of an ink input, virtual keyboard input, cut and paste input, and copy and paste input. However, in other examples, the first user input may be generated via another suitable input device such as a keyboard, mouse, touch-pad, track-pad, etc. Next at 316 the method includes receiving the first user input from the interactive display indicating a user interaction with the first GUI and the second GUI.

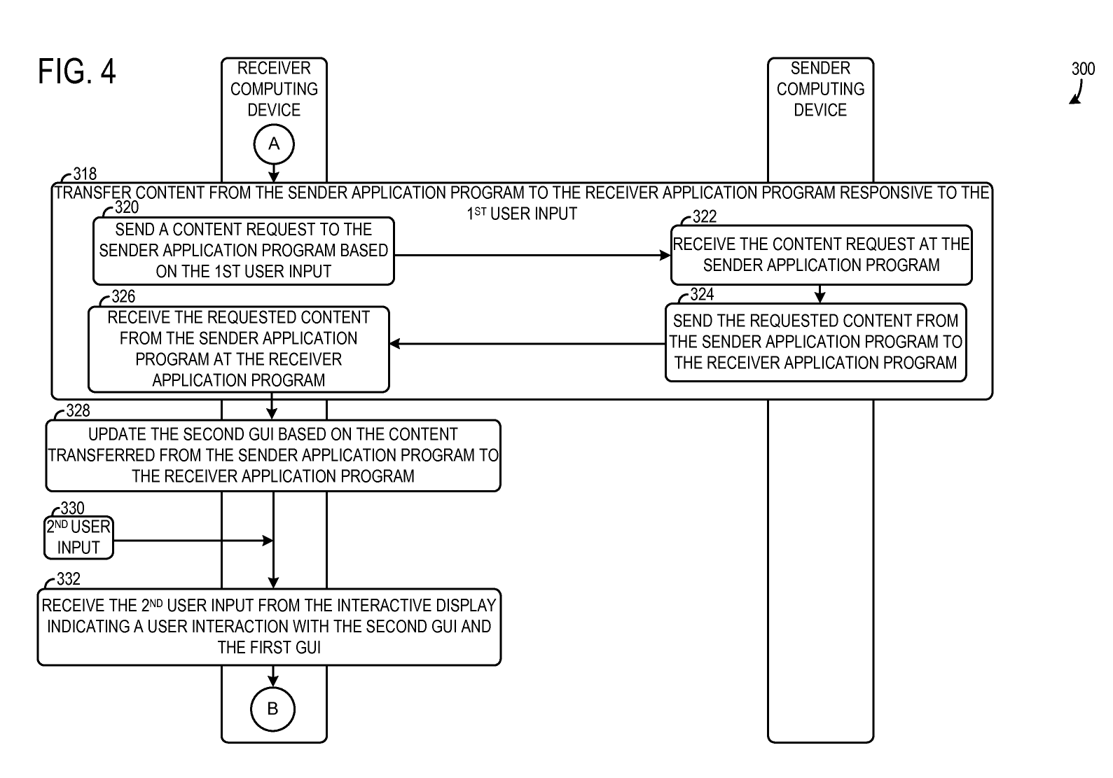

Now turning to FIG. 4, at 318 the method includes transferring content from the sender application program to the receiver application program responsive to the first user input. Transferring content from the sender application program to the receiver application program includes each of steps 320-326 or alternatively a portion of the steps 320-326.

The method includes at step 320 includes sending a content request to the sender application program based on the first user input and at 322 receiving the content request at the sender application program. In one example, the content request in sent in response to the user input. In such an example the user input may include one or more of a touch input and an ink input. In yet another example, the content request may be associated with at least one of a cut and paste function and copy and paste function.

At 324 the method includes sending the requested content from the sender application program to the receiver application program. In one example, the requested content may include graphical data and/or alphanumeric data. In such an example, the graphical data may include a screen shot of the first GUI or other snapshots of other content within the interface. Still further in another example, the requested content may be at least one of a screen-shot of the first GUI, alphanumeric data, graphical data, and cell field data.

Next at 326 the method includes receiving the requested content from the sender application program at the receiver application program. In this way, the receiver computing device may request resources from the application program remotely executed on the sender computing device.

At 328 the method includes updating the second GUI based on the content transferred from the sender application program to the receiver application program. Thus, it will be appreciated that the second GUI may be updated based on the first user input. In this way, input from the interactive display may be sent to the sender computing device for remote processing and then the second GUI displayed via the receiver computing device based on the remotely processed data. In this way, the functionality of the receiver computing device is expanded. In one example, updating the second GUI includes adjusting a graphical configuration of the second GUI based on the requested content.

Next, at 330 the method includes transferring a second user input to the receiver computing device from the interactive display (e.g., interactive touch screen). In one example, the second user input may be a touch input and/or a second ink input.

At 332 the method includes receiving the second user input from the interactive display indicating a user interaction with the second GUI and the first GUI.

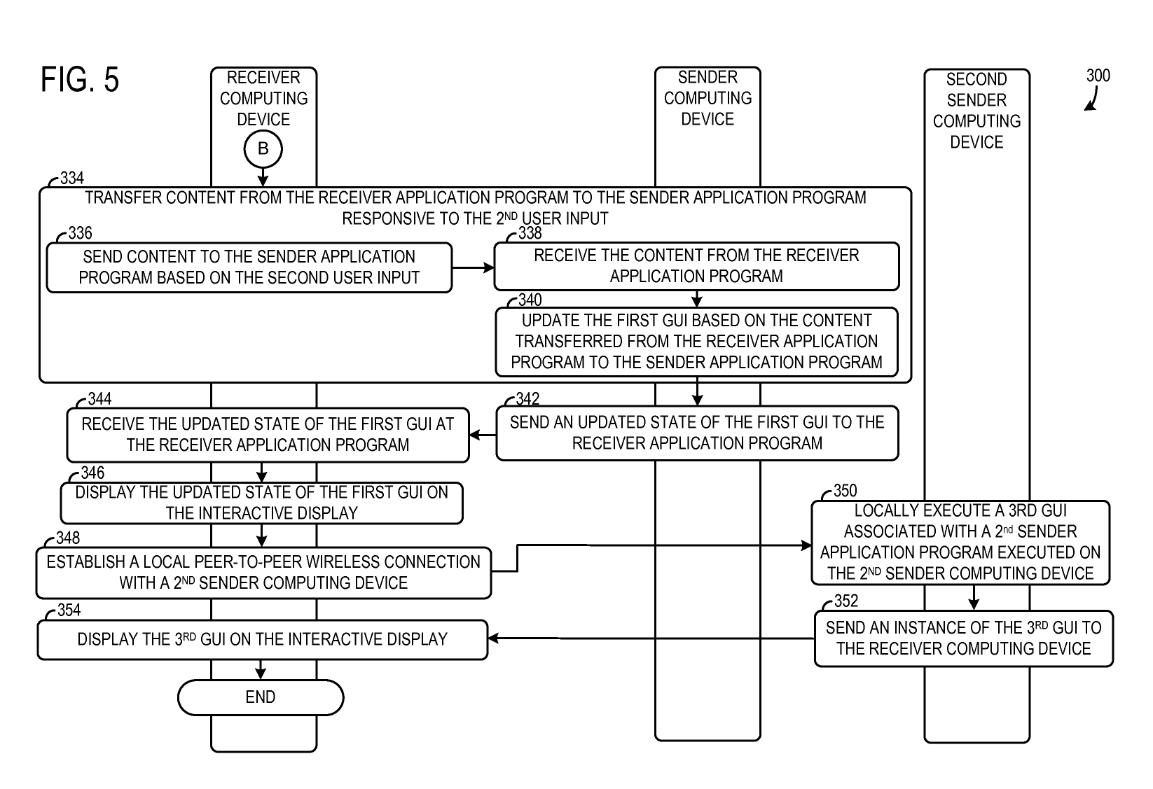

Now turning to FIG. 5, at 334 the method includes transferring content from the receiver application program on the receiver computing device to the sender application program on the sender computing device responsive to the second user input. Transferring content from the receiver application to the sender application includes steps 336-340 or alternatively a portion of steps 336-340. At 336 the method includes sending content from the receiver computing device to the sender application program based on the second user input. At 338 the method includes receiving the content at the sender application program on the sender computing device from the receiver application program. At 340 the method includes updating the first GUI based on the content transferred from the receiver application program on the receiver computing device to the sender application program on the sender computing device. Next at 342 the method includes sending an updated state of the first GUI from sender application program on the sender computing device to the receiver application program on the receiver computing device. At 344 the method includes receiving the updated state of the first GUI at the receiver application program.

At 346 the method includes displaying the updated state of the first GUI on the interactive display, on the receiver computing device. At 348 the method includes establishing a local peer-to-peer wireless connection with a second sender computing device. The local-peer-to-peer wireless connection may be one or more of a WI-FI connection and a Bluetooth connection. Next at 350 the method includes locally execute a third GUI associated with a second sender application program executed on the second sender computing device. At 352 the method includes sending an instance of the third GUI to the receiver computing device. Next at 354 the method includes displaying the third GUI on the interactive display of the receiver computing device. In one example, the first, second, and third GUIs may be simultaneously presented on the interactive display of the receiver computing device. In this way, multiple sender computing devices can display locally executed content on a single receiver computing device to enable joint interaction between the users, enabling the receiver computing device to provide a richer interactive environment.

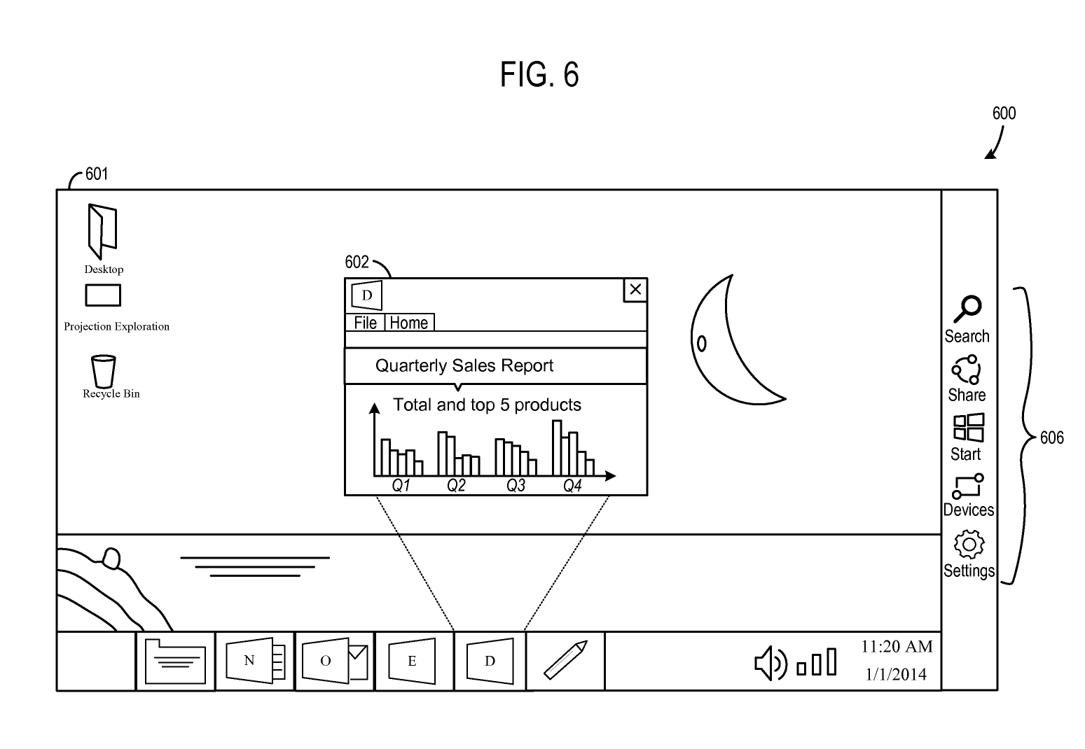

FIGS. 6-10 show different GUIs which may be executed and displayed via the receiver computing device 14, shown in FIG. 1. Thus the GUIs may be displayed on the interactive display 30, shown in FIG. 1.

FIG. 6 illustrates an example GUI 600. The GUI 600 includes a representation of a remotely executed desktop 601 and window 602 of a remotely executed application program. Buttons 606 or other suitable widgets may also be provided which enable the displayed content in the GUI 600 to be manipulated via the receiver computing device. It will be appreciated that the buttons may be locally executed on the receiver computing device.

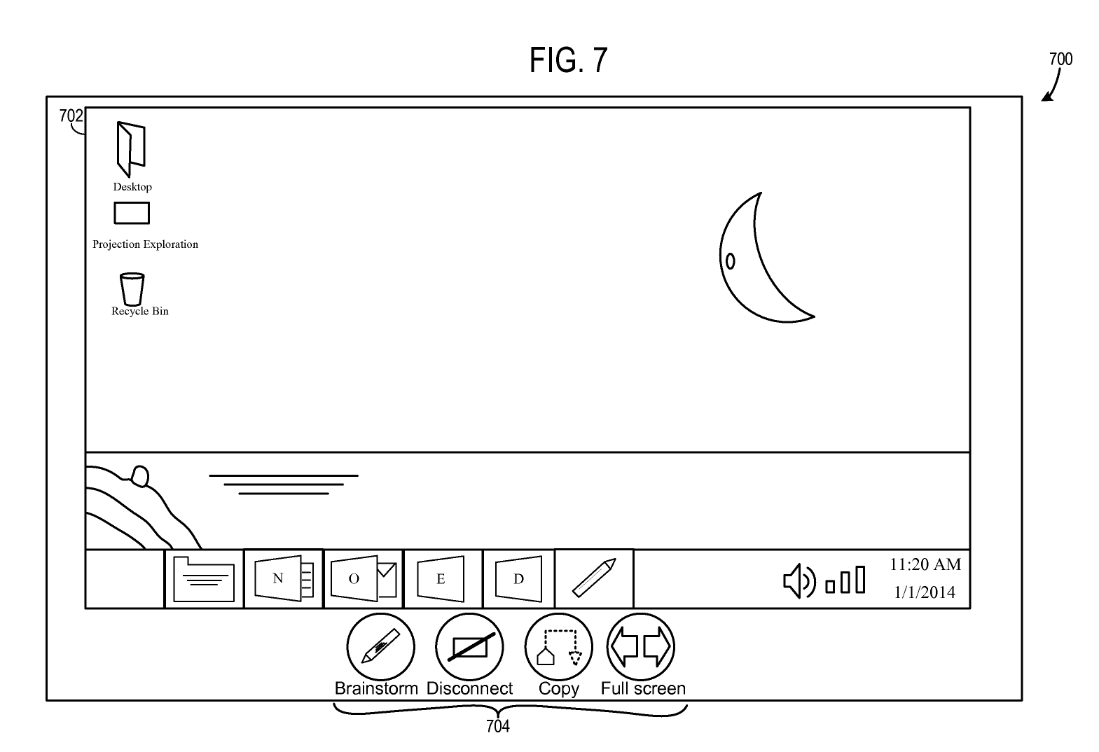

FIG. 7 illustrates another example GUI 700. The GUI 700 includes a representation of a remotely executed desktop 702. Buttons 704 or other suitable widgets may also be provided in the GUI which enables the displayed content in the GUI 700 to be copied and pasted, cut and copied, or cut and pasted, as discussed above with regard to method 300. It will be appreciated that the buttons may be locally executed on the receiver computing device. Additionally or alternatively, touch inputs can be used to cut, copy, paste, and/or otherwise manipulate the content via the receiver computing device.

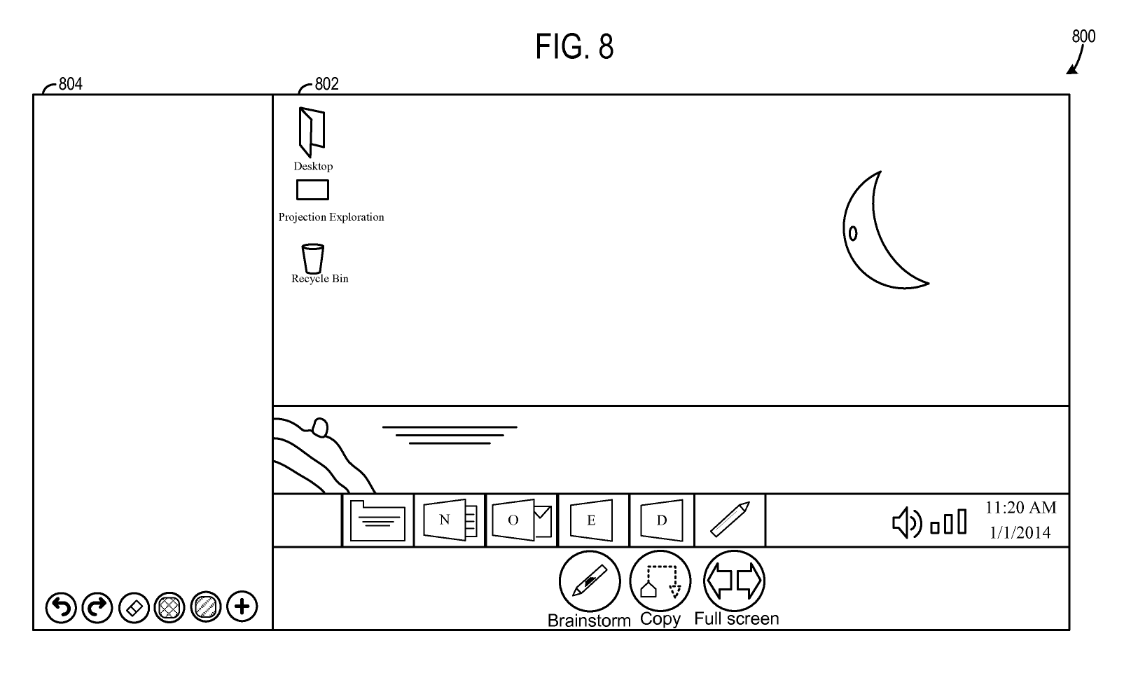

FIG. 8 shows a combined graphical interface 800 including a first GUI 802 corresponding to a remotely executed application program. As previously discussed, the remotely executed application program may be executed on the sender computing device. Additionally a second GUI 804 is shown in FIG. 8. It will be appreciated that the second GUI 804 may be associated with an application program executed on the receiver computing device. In this specific example the application program is a whiteboard application program. However, numerous application programs have been contemplated such as drawing applications, a word processing applications, etc. The whiteboard application may be configured to enable graphics and other content to be moved around and manipulated via a user.

As shown in FIG. 8, the first and second GUIs (802 and 804) are positioned side by side. However, a number of relative positions of the GUIs have been contemplated. For instance, the first GUI may be positioned within a window of the second GUI or the first GUI may be positioned above the second GUI.

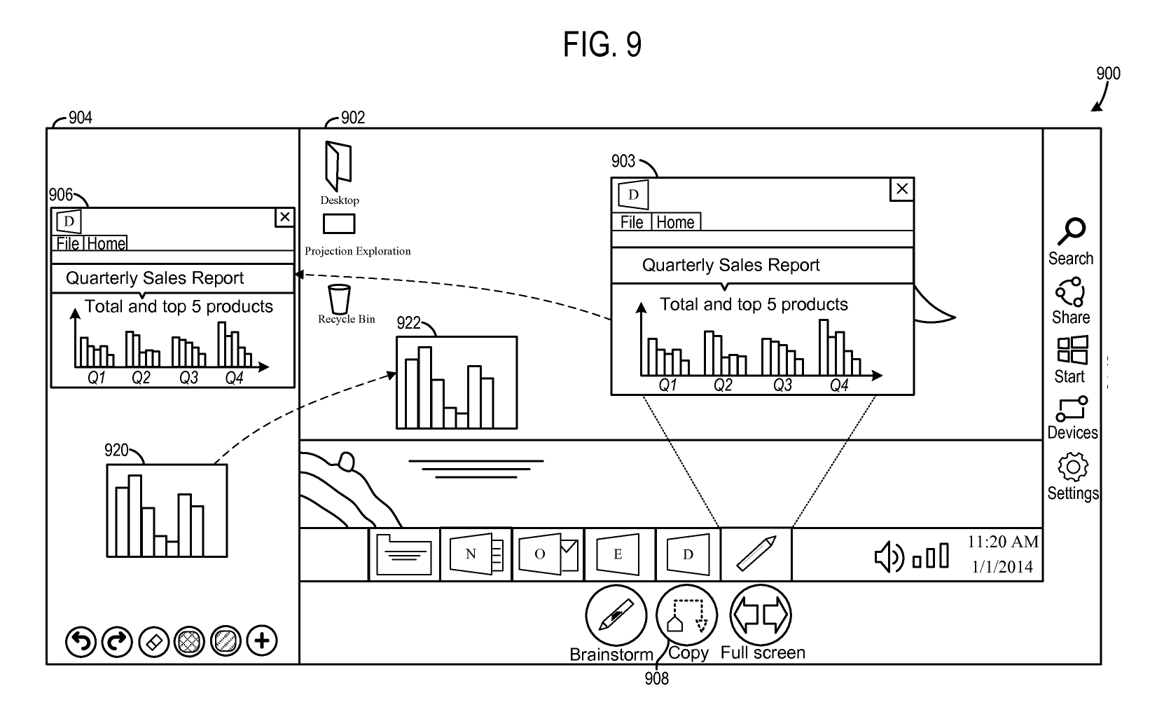

FIG. 9 shows another combined graphical user interface 900 including a remotely executed GUI 902 (e.g., first GUI) and window 903 of a remotely executed application program, which is executed on the sender computing device. The window 903 corresponds to a sender application program executed on the sender computing device, which in the depicted embodiment is a spreadsheet application program executed via the remotely executed GUI 902. However, numerous types of applications are contemplated. In the illustrated example, the window 903 includes various data from an instance of the spreadsheet application, including the structured data contained within the instance of the spreadsheet application, such as numbers, text, formulas, variables, images, etc.

Additionally a second GUI 904 is shown in FIG. 9. It will be appreciated that the second GUI 904 may be associated with a receiver application program executed on the receiver computing device. In this specific example, the application program executed on the receiver computing device is a whiteboard application program. However, other types of applications have been contemplated. As shown, a copy 906 of the window 903 presented in the first GUI 902 is pasted into the second GUI 904. Button 908 may provide this copying functionality, for example, by enabling the user to press the button 908 and then drag using touch input or stylus input the item to be copied into the destination window. As an alternative to providing a button 908, other suitable graphical user elements, gesture commands, stylus commands, voice commands, etc. may be used to implement the copy and paste functionality. The copy and paste functionality may copy an instance of the application program into the destination window, or it may copy a captured image of the application program, depending on the “paste type” selected by the user. Although the contents of an entire window are being copied in the depicted example, it will be appreciated that only a portion of the window 903 may be pasted into the second GUI 904. For example, various types of structured data objects, icons, alphanumeric symbols, etc., may be copied from portions of the window 903 and pasted into the second GUI 904. After the copy and paste function has occurred, the receiver computing device is configured to transmit the copied and pasted data back to the sender computing device, so that the remotely executed application program executed on the sender computing device can receive and appropriately process the data. The results of this processing by the remotely executed application program are, in turn, transmitted to and displayed on the receiver computing device.

A window 920 presented in the second GUI 904 is also shown. The window 920 may be executed via receiver computing device. Specifically, the window 920 may be associated with an application program locally executed via the receiver computing device. As shown, a copy 922 of the window 920 may be transferred to the first GUI 902. Transferring the data may include sending content from the receiver application program to the sender application program. Thus, the window may be copied and pasted or alternatively cut and pasted into the first GUI 902. In this way, content from the locally executed GUI may be transferred to the remotely executed GUI. It will be appreciated that other content may be transferred from the second GUI to the first GUI such as alphanumeric data, cell field data, images, etc.

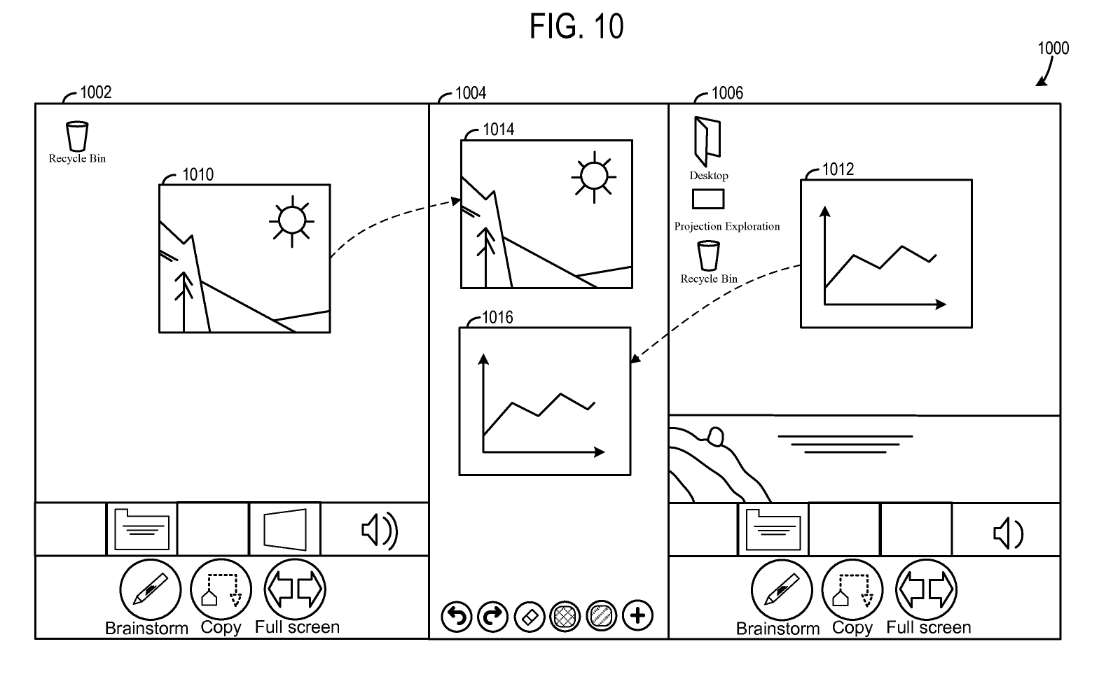

FIG. 10 shows another combined GUI 1000. The combined GUI 1000 shown in FIG. 100 enable two sender computing devices to connect with the receiver computing device and display remotely executed GUIs on a display corresponding to the receiver computing device.

In particular, a first GUI 1002 associated with a first sender computing device, a second GUI 1004 associated with a receiver computing device, and a third GUI 1004 associated with a second sender computing device. In this way, three GUIs may be simultaneous displayed via an interactive display, two of which are remotely executed. Consequently, users of different sender computing devices can have content executed via the sender computing devices displayed and manipulated via the interactive display.

As shown, windows 1010 and 1012 associated with the first GUI 1002 and the third GUI 1006 may each be copied into the second GUI 1004 at windows 1014 and 1016, respectively. Alternatively in other examples, the windows 1010 and 1012 may be cut and copied into the second GUI 1004. Still further in other examples, additional or alternate types of data may be transferred between the GUI's.

As a variation on the above described configurations, the connection between the sender computing device and receiver computing device may be formed over a wireless protocol for sending image data from the sender to the receiver, and a wired connection may be formed over a cable, such as a USB cable, for transferring content from the locally executed program on the receiver device to the remotely executed program on the sender device. As yet another variation, the image data may be sent from the sender to the receiver over a wired connection, using, for example, an HDMI cable, and a USB cable may be provided for the return transfer of content from the receiver to the sender computing device. In this way, computing devices that do not natively support fully wireless bidirectional communications as described herein may nonetheless use a wired connection for transferring content back to the sender device.

The above described systems and methods have the potential advantage that they enable content to be transferred from a remotely executed application program to a locally executed application program on a receiver computing device having interactive capabilities, such as touch and ink input capabilities. As a result, a user can easily and intuitively manipulate locally as well as remotely executed content on the display of the receiver computing device, thereby expanding the functionality of the receiver device. Furthermore, this expanded device functionality also increases the resources available to the user for content management and manipulation on the device. Consequently, the aforementioned method provides greater collaborative functionality between participants in meetings as well as other interactive settings such as presentations, lectures, etc.

Turning now to the hardware configuration of the system, in some embodiments, the methods and processes described herein may be tied to a computing system of one or more computing devices. In particular, such methods and processes may be implemented as a computer-application program or service, an application-programming interface (API), a library, and/or other computer-program product.

The processors described herein may include one or more physical devices configured to execute instructions. For example, the processors may be configured to execute instructions that are part of one or more applications, services, programs, routines, libraries, objects, components, data structures, or other logical constructs. Such instructions may be implemented to perform a task, implement a data type, transform the state of one or more components, achieve a technical effect, or otherwise arrive at a desired result.

The processors may include one or more components configured to execute software instructions. Additionally or alternatively, the processors may include one or more hardware or firmware logic machines configured to execute hardware or firmware instructions. The processors may be single-core or multi-core, and the instructions executed thereon may be configured for sequential, parallel, and/or distributed processing. Individual components of the processors optionally may be distributed among two or more separate devices, which may be remotely located and/or configured for coordinated processing. Aspects of the processors may be virtualized and executed by remotely accessible, networked computing devices configured in a cloud-computing configuration.

The memory described herein may include removable and/or built-in devices. The memory described herein may include optical memory (e.g., CD, DVD, HD-DVD, Blu-Ray Disc, etc.), semiconductor memory (e.g., RAM, EPROM, EEPROM, etc.), and/or magnetic memory (e.g., hard-disk drive, floppy-disk drive, tape drive, MRAM, etc.), among others. The memory described herein may include volatile, nonvolatile, dynamic, static, read/write, read-only, random-access, sequential-access, location-addressable, file-addressable, and/or content-addressable devices.

It will be appreciated that memory described herein includes one or more physical devices. However, aspects of the instructions described herein alternatively may be propagated by a communication medium (e.g., an electromagnetic signal, an optical signal, etc.) that is not held by a physical device for a finite duration.

Aspects of the processors and memory described herein may be integrated together into one or more hardware-logic components. Such hardware-logic components may include field-programmable gate arrays (FPGAs), program- and application-specific integrated circuits (PASIC/ASICs), program- and application-specific standard products (PSSP/ASSPs), system-on-a-chip (SOC), and complex programmable logic devices (CPLDs), for example.

The term “application program” may be used to describe an aspect of the computing system implemented to perform a particular function. In some cases, the application program may be instantiated via a processor executing instructions held by memory. It will be understood that different application programs may be instantiated from the same service, code block, object, library, routine, API, function, etc. Likewise, the same application program may be instantiated from different services, code blocks, objects, routines, APIs, functions, etc. The terms “application program” may encompass individual or groups of executable files, data files, libraries, drivers, scripts, database records, etc.

When included, display devices may be used to present a visual representation of data held by memory. This visual representation may take the form of a graphical user interface (GUI). As the herein described methods and processes change the data held by memory, and thus transform the state of the memory, the state of the displays may likewise be transformed to visually represent changes in the underlying data. Display devices may be combined with processor and memory in a shared enclosure, or such display devices may be peripheral display devices.

It will be understood that the configurations and/or approaches described herein are exemplary in nature, and that these specific embodiments or examples are not to be considered in a limiting sense, because numerous variations are possible. The specific routines or methods described herein may represent one or more of any number of processing strategies. As such, various acts illustrated and/or described may be performed in the sequence illustrated and/or described, in other sequences, in parallel, or omitted. Likewise, the order of the above-described processes may be changed.

The subject matter of the present disclosure includes all novel and nonobvious combinations and subcombinations of the various processes, systems and configurations, and other features, functions, acts, and/or properties disclosed herein, as well as any and all equivalents thereof.

The subject matter of the present disclosure is further described in the following paragraphs. According to one aspect, a method for providing collaborative communication between computing devices. The method include at a receiver computing device, displaying a first graphical user interface (GUI) and a second GUI on an interactive display, the first GUI associated with a remotely executed sender application program executed on a sender computing device having a local peer-to-peer wireless connection with the receiver sender computing device and the second GUI associated with a locally executed receiver application program executed on the receiver computing device; receiving a user input from the interactive display indicating user interaction with the first GUI and the second GUI; sending a content request to the sender application program from the receiver application program based on the user input; receiving the content requested from the sender application program; and updating the second GUI based on the content transferred from the sender application program to the receiver application program.

In this aspect, the content request may be sent in response to the user input, the user input including one or more of a touch input and an ink input.

In this aspect, the first GUI and the second GUI may be simultaneously displayed on the interactive display.

In this aspect, the content request is associated with at least one of a cut and paste function and copy and paste function.

In this aspect, the content may include graphical data and alphanumeric data.

In this aspect, where graphical data may include a screen shot of the first GUI.

In this aspect, the method may further include at the receiver computing device, receiving a second user input from the interactive display indicating a user interaction with the first GUI and the second GUI and transferring content from the receiver application program to the sender application program responsive to the user input indicating user interaction with the first GUI and the second GUI.

In this aspect, the method may further include at the receiver computing device, establishing a second local peer-to-peer wireless connection with a second sender computing device, receiving from the second sender computing device via the second local peer-to-peer wireless an instance of a third GUI of a second sender application program that is executed on the second sender computing device, and displaying the third GUI on the interactive display.

In this aspect, the first, second, and third GUI's may be simultaneously presented on the interactive display.

In this aspect, the first GUI may be presented within a window of the second GUI.

In this aspect, the local peer-to-peer wireless connection may be at least one of a WI-FI connection and a Bluetooth connection.

According to another aspect, a receiver computing device is provided. The receiver computing device includes an interactive touch screen; and code stored in memory executable by a processor to: simultaneously display a first graphical user interface (GUI) and a second GUI on the interactive touch screen, the first GUI associated with a remotely executed sender application program executed on a sender computing device having a local peer-to-peer wireless connection with the receiver sender computing device and the second GUI associated with a locally executed receiver sender application program executed on the receiver computing device; receive user input from the interactive touch screen indicating a user interaction with the first GUI and the second GUI; send a content request to the sender application program from the receiver application program based on the user input; receive the requested content from the sender application program to the receiver application program; and update the second GUI based on the content transferred from the sender application program to the receiver application program.

In this aspect, the user input may be one of ink input, virtual keyboard input, cut and paste input, and copy and paste input.

In this aspect, the requested content may be at least one of a screen-shot of the first GUI, alphanumeric data, graphical data, and cell field data.

In this aspect, the user input may be one of a multi-touch user input and an ink input, the multi-touch input indicating a plurality of touch inputs with the interactive touch screen and the ink input indicating stylus interaction with the interactive touch screen.

In this aspect, the local peer-to-peer wireless connection may be at least one of a WI-FI connection and a Bluetooth connection.

According to another aspect, a method for providing collaborative communication between computing devices is provided. The method includes at receiver computing device, simultaneously displaying a first graphical user interface (GUI) and a second GUI on an interactive touch screen, the first GUI associated with a remotely executed sender application program executed on a sender computing device having a local WI-FI connection with the receiver sender computing device and the second GUI associated with a locally executed receiver application program executed on the receiver computing device; receiving a touch input or an ink input from the interactive touch screen indicating user interaction with the first GUI and the second GUI; send a content request to the sender application program from the receiver application program responsive to the touch input or the ink input; receiving the requested content from the sender application program to the receiver application program; and updating the second GUI based on the content transferred from the sender application program to the receiver application program.

In this aspect, the content may include one or more of a screen shot of the first GUI, alphanumeric data, graphical data, and cell field data.

In this aspect, updating the second GUI may include adjusting a graphical configuration of the second GUI based on the requested content.

In this aspect, the method may further include at the receiver computing device, receiving a second touch input or a second ink input from the interactive touch screen indicating a user interaction with the first GUI and the second GUI and transferring content from the receiver application program to the sender application program responsive to the user input indicating user interaction with the first GUI and the second GUI.

1. A method for providing collaborative communication between computing devices, the method comprising:
at a receiver computing device, displaying a first graphical user interface (GUI) and a second GUI on an interactive display, the first GUI associated with a remotely executed sender application program executed on a sender computing device having a local peer-to-peer wireless connection with the receiver sender computing device and the second GUI associated with a locally executed receiver application program executed on the receiver computing device;
receiving a user input from the interactive display indicating user interaction with the first GUI and the second GUI;
sending a content request to the sender application program from the receiver application program based on the user input;
receiving the content requested from the sender application program; and
updating the second GUI based on the content transferred from the sender application program to the receiver application program.

2. The method of claim 1, where the content request is sent in response to the user input, the user input including one or more of a touch input and an ink input.

3. The method of claim 1, where the first GUI and the second GUI are simultaneously displayed on the interactive display.

4. The method of claim 1, where the content request is associated with at least one of a cut and paste function and copy and paste function.

5. The method of claim 1, where content includes graphical data and alphanumeric data.

6. The method of claim 5, where the graphical data includes a screen shot of the first GUI.

7. The method of claim 1, further comprising at the receiver computing device, receiving a second user input from the interactive display indicating a user interaction with the first GUI and the second GUI and transferring content from the receiver application program to the sender application program responsive to the user input indicating user interaction with the first GUI and the second GUI.

8. The method of claim 1, further comprising at the receiver computing device, establishing a second local peer-to-peer wireless connection with a second sender computing device, receiving from the second sender computing device via the second local peer-to-peer wireless an instance of a third GUI of a second sender application program that is executed on the second sender computing device, and displaying the third GUI on the interactive display.

9. The method of claim 8, where the first, second, and third GUI's are simultaneously presented on the interactive display.

10. The method of claim 1, where the first GUI is presented within a window of the second GUI.

11. The method of claim 1, where the local peer-to-peer wireless connection is at least one of a WI-FI connection and a Bluetooth connection.

12. A receiver computing device comprising:
an interactive touch screen; and
code stored in memory executable by a processor to:
simultaneously display a first graphical user interface (GUI) and a second GUI on the interactive touch screen, the first GUI associated with a remotely executed sender application program executed on a sender computing device having a local peer-to-peer wireless connection with the receiver sender computing device and the second GUI associated with a locally executed receiver sender application program executed on the receiver computing device;
receive user input from the interactive touch screen indicating a user interaction with the first GUI and the second GUI;
send a content request to the sender application program from the receiver application program based on the user input;
receive the requested content from the sender application program to the receiver application program; and
update the second GUI based on the content transferred from the sender application program to the receiver application program.

13. The receiver computing device of claim 12, where the user input is one of ink input, virtual keyboard input, cut and paste input, and copy and paste input.

14. The receiver computing device of claim 12, where the requested content is at least one of a screen-shot of the first GUI, alphanumeric data, graphical data, and cell field data.

15. The receiver computing device of claim 12, where the user input is one of a multi-touch user input and an ink input, the multi-touch input indicating a plurality of touch inputs with the interactive touch screen and the ink input indicating stylus interaction with the interactive touch screen.

16. The receiver computing device of claim 12, where the local peer-to-peer wireless connection is at least one of a WI-FI connection and a Bluetooth connection.

17. A method for providing collaborative communication between computing devices, the method comprising:
at receiver computing device, simultaneously displaying a first graphical user interface (GUI) and a second GUI on an interactive touch screen, the first GUI associated with a remotely executed sender application program executed on a sender computing device having a local WI-FI connection with the receiver sender computing device and the second GUI associated with a locally executed receiver application program executed on the receiver computing device;
receiving a touch input or an ink input from the interactive touch screen indicating user interaction with the first GUI and the second GUI;
send a content request to the sender application program from the receiver application program responsive to the touch input or the ink input;
receiving the requested content from the sender application program to the receiver application program; and
updating the second GUI based on the content transferred from the sender application program to the receiver application program.

18. The method of claim 17, where the content includes one or more of a screen shot of the first GUI, alphanumeric data, graphical data, and cell field data.

19. The method of claim 17, where updating the second GUI includes adjusting a graphical configuration of the second GUI based on the requested content.

20. The method of claim 17, further comprising, at the receiver computing device, receiving a second touch input or a second ink input from the interactive touch screen indicating a user interaction with the first GUI and the second GUI and transferring content from the receiver application program to the sender application program responsive to the user input indicating user interaction with the first GUI and the second GUI.
